(19) United States
(12) Patent Application Publication
(10) Pub. No.: US 2004/0098481 A1
(43) Pub. Date: May 20, 2004

(54) Computer-user authentication system, method and program therefor

(75) Inventors: Masao Gunji, Kawasaki (JP); Hisashi Katsuyama, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/704,750

(22) Filed: Nov. 12, 2003

(30) Foreign Application Priority Data
Nov. 18, 2002 (JP) 2002-333467

(51) Int. Cl. G06F 15/16; G06F 15/173

(52) U.S. Cl. 709/225; 709/229

(57) ABSTRACT

A computer-user authentication system comprising a simplified remote controller substituted for input operation of the ID and the PW to the computer is provided, which improves the operability and the security.

The computer user authenticating system comprises: a transmitter that transmits a predetermined wireless signal triggered by a push button on an input section in the transmitter, a receiver that receives the wireless signal, and a computer that communicates with the receiver and authenticates an operator of the transmitter after receiving the wireless signal as a trigger. The transmitter comprises a unit that authenticates the operator of the transmitter based on the finger print, and transmits the wireless signal only when the operator is authenticated by the authenticating unit.

### BACKGROUND OF THE INVENTION

1. Field of the Invention

The present invention relates to a computer-user authentication system, method and program therefor. The system protects a user of a computer from dishonest access to the computer by a third party and safely secures secret information by allowing only the user to access to the computer.

In general, when logging in to a computer, activating/deactivating a screen saver or logging in to the other computer via an internet, it is required to input an identification (ID) number and a password (PW) of a user to the computer in order to authenticate the user. To simplify the above input operation, a remote controller with a push button has been provided which button functions to automatically input the ID and the PW. However, if the remote controller is stolen and used by a third party, the secret information in the computer may be lost. Therefore, it is desired to provide a system in which the computer cannot be used by the third party even if the remote controller is stolen.

2. Description of the Related Art

Conventionally, when logging in to a computer, activating/deactivating a screen saver or logging in to the other computer via an internet, it is required to input an identification (ID) number and a pass word (PW) of a user to the computer in order to authenticate the user. To enhance the security, the password of the user may be complicated. However, if the PW is complicated, the user may forget the PW. Accordingly, the user needs to input the PW by referring to a note on which the PW is written. There is a possibility that the note can be stolen. On the other hand, when a specific device such as a remote controller is used as a key, namely when only the owner of the remote controller is allowed to use the computer, there is also a possibility that the controller can be stolen and dishonestly used by a third party.

To enhance the security even when the controller is stolen, an authentication system, disclosed in the Japanese Unexamined Patent Publication (JPP) No. H11-19762, is provided. In the system, an ID and a PW are previously registered in the remote controller, then a user inputs his or her PW into the controller. If the registered Pw coincides with the input PW, the PW is transmitted to the computer and the user is allowed to use it.

The details are described in “Scope of claim for Patent”, claim 1 and “Detailed Description of the Invention”, paragraphs 0007, 0012, 0039 and 0057, in the specification of JPP No. H11-19762.

However, the above system still has a problem in that inputting the PW is time consuming and there is a possibility that a note of the PW can be stolen. Accordingly, it has been desired to provide a system that improves the input operation at the authentication time when a user accesses to a computer and that protects a user of a computer from dishonest access to the computer by a third party and guarantees the security of secret information.

An infrared remote controller used for a terminal is disclosed in JPP No. 2000-350268 which turns on or off the power supply to the terminal of a personal computer or the like by a push button in the remote controller according to claim 1, receives display information from the terminal, displays on a display in the controller, and sends various commands to the terminal based on information displayed in the controller according to claim 2, and authenticates the user of the controller by his or her fingerprint according to claim 3.

The details are described in “Scope of claim for Patent” and “Detailed Description of the Invention”, Paragraphs 0003 and 0006, in the specification of JPP No. 2000-350268.

The infrared remote controller disclosed in JPP No. 2000-350268 can improve the security. The controller also improves the operability because it is only required to depress a push button to turn on or off the power supply of the terminal of the computer or the like. However, it does not include an input operation when authenticating the user of the computer.

On the other hand, the authentication system according to JPP No. H11-191762 has a problem in that a user of a computer must input his or her PW to the remote controller every time using the computer. This operation is time consuming. In addition, in order to make a computer execute various processes in the same way as the controller disclosed in JPP No. 2000-350268, the remote controller is required to have a transmitting function to transmit the PW to the computer and a receiving function to receive information from the computer, which makes the constitution of the remote controller complicated.

### SUMMARY OF THE INVENTION

Accordingly, the object of the present invention is to solve the above-mentioned problems and to provide a computer-user authentication system, method and program therefor, wherein the system comprises a simplified remote controller substituted for an input operation of an ID and a PW of a user to a computer, which is required for authentication of the user of the computer, whereby improving the operability upon authenticating the computer user, and protects the user from dishonest access to the computer by a third party even if the remote controller is stolen, and safely secures secret information.

In order to solve the above problems, according to the present invention, a system of authenticating a computer user is provided which includes:

a transmitter that transmits a predetermined wireless signal;

a receiver that receives the wireless signal; and

a computer that communicates with the receiver and authenticates an operator of the transmitter after receiving the wireless signal as a trigger.

The above system further includes a registering unit that registers a personal identification data in advance corresponding to the wireless signal in a memory unit of the receiver.

In the above system, the registering unit enters, in advance, the personal identification data in response to a screen state on a display of the computer in a memory unit of the receiver.

In the above system, the receiver receives the wireless signal from the transmitter, indicates that it has received the signal to the computer, reads personal identification data corresponding to the wireless signal and registered in the memory unit, and inputs the read personal identification data to the computer.

In the above system, the receiver receives the wireless signal from the transmitter, indicates that it has received the signal to the computer; and

the computer reads personal identification data corresponding to the wireless signal from the receiver.

In the above system, the receiver receives the wireless signal from the transmitter, indicates that it has received the signal to the computer; and

the computer reads personal identification data from the receiver, corresponding to screen information of the computer, when it has received the wireless signal.

In the above system, the transmitter includes a authenticating unit that authenticates an operator of the transmitter based on at least one of personal features such as signature patterns, fingerprint patterns, palm print patterns, voiceprint patterns, or the like; and

the wireless signal is transmitted only when the operator is authenticated by the authenticating unit.

In order to solve the above problems, according to the present invention, a method of authenticating a computer user is provided which includes: the steps of:

receiving a notice that a predetermined wireless signal has been received via a receiver in which the wireless signal is transmitted from the transmitter and triggered by an operation of an operator of the transmitter; and

authenticating the operator of the transmitter as a result of the communication with the receiver.

The above method further includes a step of reading personal identification data corresponding to screen information of the computer when the notice from the receiver is received.

The above method further includes a step of reading personal identification data corresponding to screen information of the computer when the notice from the receiver is received.

The above method includes the steps of authenticating an operator of the transmitter based on at least one of personal features such as signature patterns, fingerprint patterns, palm print patterns, voiceprint patterns or the like; and

transmitting the wireless signal only when the operator is authenticated.

In order to solve the above problems, according to the present invention, a computer program is provided for a method of authenticating a computer user that makes the computer execute the steps of:

receiving a notice that a predetermined wireless signal has been received via a receiver in which the wireless signal is transmitted from the transmitter and triggered by an operation of an operator of the transmitter; and

authenticating the operator of said transmitter as a result of the communication with the receiver.

### BRIEF DESCRIPTION OF THE DRAWINGS

FIG. 1 is a block diagram showing an embodiment of a computer-user authentication system according to the present invention;

FIG. 2 is a block diagram showing a computer as shown in FIG. 1 in detail;

FIG. 3 is a front view of an example of a transmitter of a first embodiment according to the present invention;

FIG. 4 is a block diagram of a transmitter of a first embodiment according to the present invention;

FIG. 5 is a block diagram of a receiver of a first embodiment according to the present invention;

FIG. 6 is a functional block diagram of a transmitter of a second embodiment according to the present invention;

FIG. 7 is a functional block diagram of a receiver of a second embodiment according to the present invention;

FIG. 8A is a drawing showing an example of a table (A) stored in a receiver;

FIG. 8B is a drawing showing an example of a table (B) stored in a receiver;

FIG. 9 is a drawing showing an example of a screen displayed on a display of a computer;

FIG. 10 is a flowchart showing a procedure of creating a definition object describing a sequence of entering at a computer in order to carry out the present invention;

FIG. 11 is a flowchart showing a routine of a transmitter that authenticates an operator of the transmitter based on personal features of the operator;

FIG. 12 is a flowchart showing a procedure of a receiver that receives a wireless signal from a transmitter and inputs a personal identification data to a computer; and

FIG. 13 is a flowchart showing a procedure that receives a wireless signal from a transmitter and inputs a personal identification data to a computer in accordance with a state of a screen of the computer.

### DESCRIPTION OF THE PREFERRED EMBODIMENTS

Referring to drawings, the preferred embodiments of the present invention will be explained in detail hereinafter.

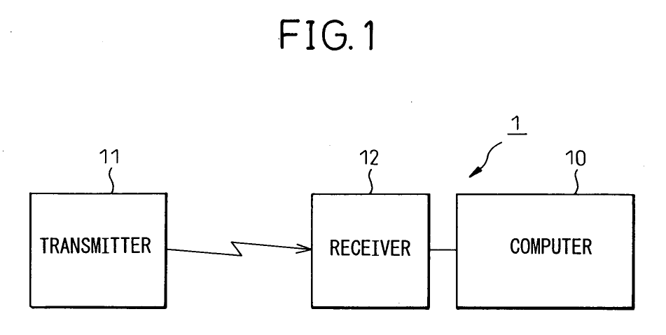

FIG. 1 is a block diagram showing an embodiment of a computer-user authentication system according to the present invention. The authentication system 1, generally shown on FIG. 1, includes a computer 10, a transmitter 11 and a receiver 12. The transmitter 11 transmits prescribed wireless signals in order to identify a user of the computer 10. The receiver 12 receives the transmitted wireless signals and stores personal identification data corresponding to the wireless signals, beforehand. The computer 10 communicates with the receiver 12 when a wireless signal from the transmitter 11 is received by the receiver 12, and authenticates the operator of the transmitter 11.

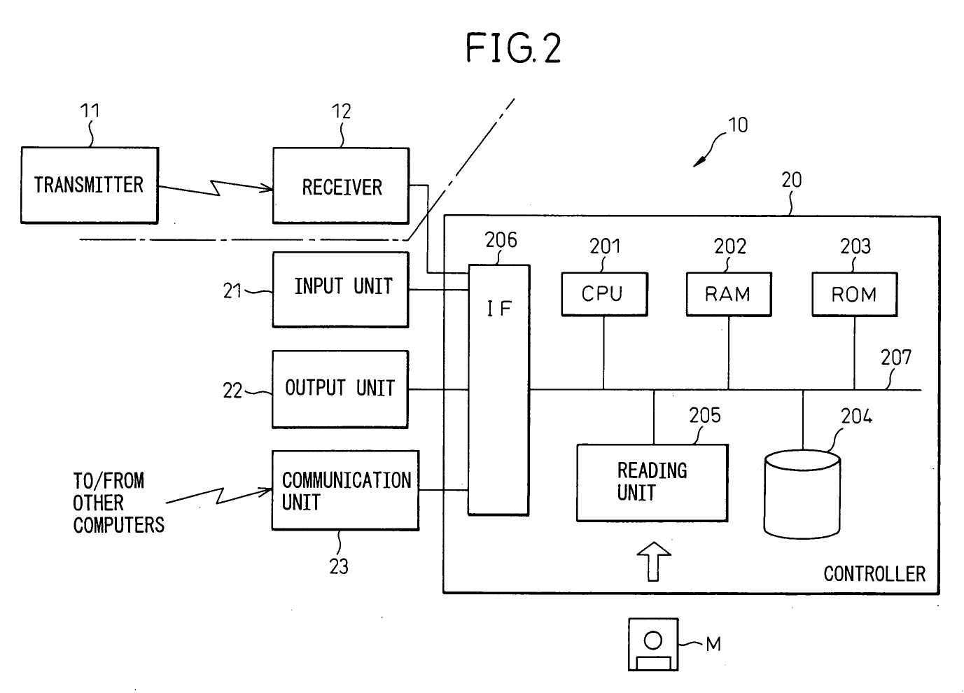

FIG. 2 is a block diagram of a computer 10 as shown in FIG. 1 in detail. In FIG. 2, the computer 10 is shown in lower right part divided by an alternate long and short dashed line. The computer 10 includes a controller 20, an input unit 21 such as a key board, a mouse or the like, an output unit 22 such as a display, a printer or the like, and a communication unit 23 that transmits and receives programs and data between the controller 20 and other outside computers via a LAN or an internet.

The controller 20 includes a CPU 201, a RAM 202 or a main store, used for a temporary memory area of programs executed by the CPU 201 and data and also used for a work area of the CPU 201, a ROM 203 used for storing fixed programs and data, an auxiliary memory unit 204 such as a magnetic disk or the like for storing programs and data to be written in the RAM 202 when required, a reading unit 205 for reading programs and data recorded on a recording medium M such as a flexible disc (FD), a compact disc or the like, and an interface (IF) 206. The interface 206 is connected to the receiver 12, the input unit 21, the output unit 22 and the communication unit 23, and enables the CPU 201 to communicate with them. The CPU 201, the RAM 202, the ROM 203, the auxiliary unit 204, the reading unit 205 and the interface 206 are connected each other via a bus line 207 for mutual communication.

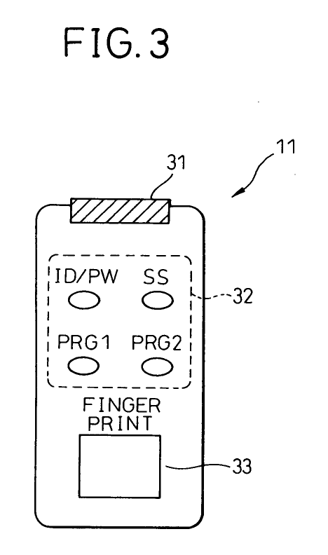

FIG. 3 is a front view of an example of a transmitter of a first embodiment according to the present invention. The transmitter 11 includes an infrared ray emitting section 31 that emits an infrared ray as a wireless signal, a push button input section 32, a fingerprint input section 33 and a built-in micro computer.

In the push button input section 32, push buttons such as ID/PW, SS, PRG1 and PRG2 are arranged and used for inputting a user ID and a PW to the computer 10. The push button ID/PW is depressed when a user logs in to the computer, the push button SS is depressed when the user activates or deactivates the screen saver, and the push buttons PRG1 and PRG2 are respectively depressed when the user logs in to a first home page and a second home page via an internet.

The fingerprint input section 33 is reserved for a place where a finger, for example a thumb of a right hand, of an operator of the transmitter 11, is laid. The section 33 determines whether the operator is a user having registered in advance or not, before transmitting wireless signals corresponding to push the buttons ID/PW, SS, PRG1 and PRG2, from the transmitter 11 to the receiver 12, when any one of the push buttons is depressed.

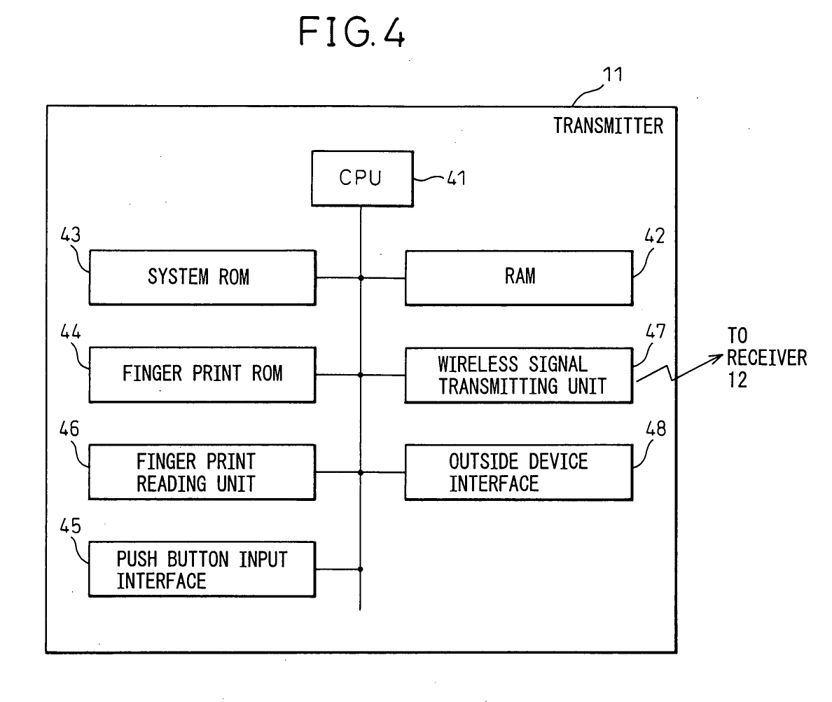

FIG. 4 is a block diagram of a transmitter of a first embodiment according to the present invention. The transmitter 11 is composed of a general micro processor that includes a CPU 41, a RAM 42 or a main store, used for a temporary memory area and a work area of the CPU 41, a system ROM 43 used for storing such a program executed by CPU 41 as that authenticates a fingerprint, a ROM 44 used for storing fingerprint image data of users of the transmitter 11 in advance, a push button input interface 45, a fingerprint reading unit 46, a wireless signal transmitting unit 47 and an interface 48 with outside devices.

The push button input interface 45 functions to input an on or off signal of the push buttons, ID/PW, SS, PRG1 and PRG2 in the section 32 as shown in FIG. 3, to the CPU 41.

The fingerprint reading unit 46 reads a fingerprint of a user with the use of a known fingerprint reader incorporating a CCD camera using a solid state image pick-up component therein, and creates the fingerprint image data. The wireless signal is transmitted only when it is determined that they are coincident as a result of the comparison between the image data of this fingerprint created in the reading unit 46 and the fingerprint data of the user stored in the ROM 44 in advance.

The wireless signal transmitting unit 47 emits an infrared ray in a predetermined transmitting speed toward the receiver 12 in response to a unique bit string of an infrared ray signal corresponding to one of the push buttons ID/PW, SS, PRG1 and PRG2. The infrared ray signal is generated by a trigger of an on signal of each of the push buttons. The infrared ray signal is created in accordance with the IrDA, or Infrared Data Association, standard, which defines a mutual connection by infrared ray data communications.

The interface 48 connects outside devices via a Universal Serial Bus, which is used when a fingerprint of an operator of the transmitter 11 is registered.

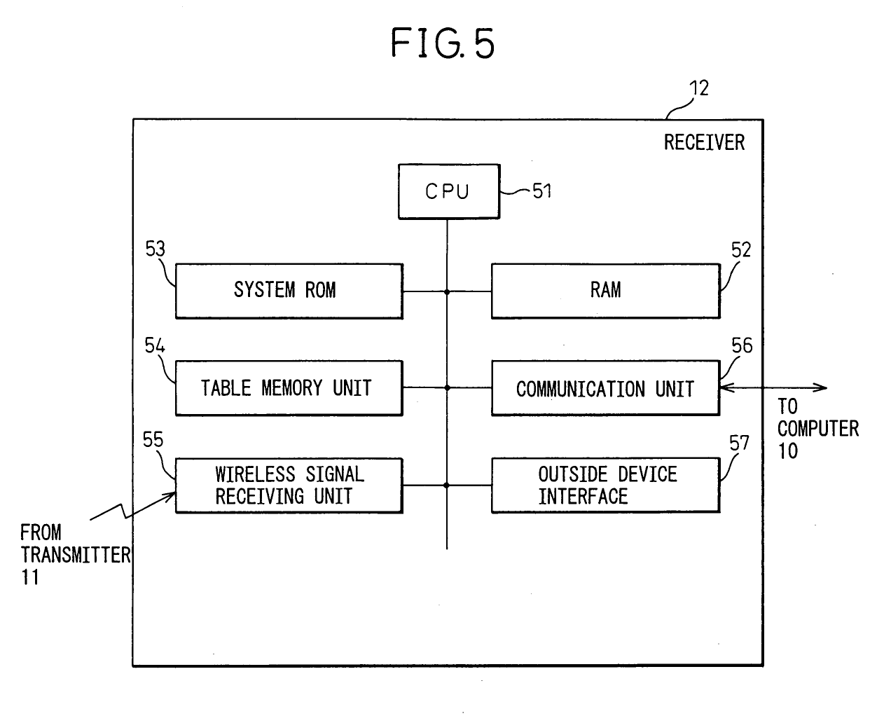

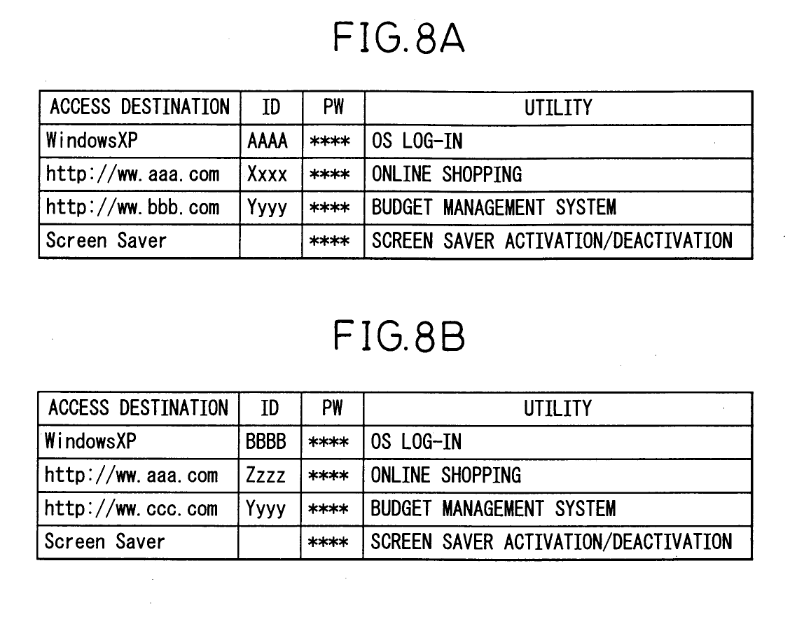

FIG. 5 is a block diagram of a receiver of a first embodiment according to the present invention. The receiver 12 is composed of a general micro processor that includes a CPU 51, a RAM 52 or a main store, used for a temporary memory area and a work area of the CPU 51, a system ROM 53 used for storing such a program executed by CPU 51 as that authenticates a user, a memory unit 54 composed of a RAM for storing table data of a personal ID data as shown in FIGS. 8A and 8B, a wireless signal receiving unit 55, a communication unit 56 and an interface 57 with outside devices.

The wireless signal receiving unit 55 receives an infrared ray signal emitted from the transmitter 11 and converts it into an electronic signal.

The communication unit 56 transfers data of the electronic signal converted by the wireless signal receiving unit 55 to the computer 10, receives a command from the computer 10, reads the personal ID data stored in the table memory unit 54 in response to the command and inputs the read ID data to the CPU 201 in the controller 20.

The interface 57 is connected with any one of outside devices via a USB (Universal Serial Bus) when tables are stored in the table memory unit 54. It is also possible to store the tables in the table memory unit 54 from the computer 10 via the communication unit 56.

Next, a transmitter and a receiver according to a second embodiment of the present invention will be explained. The transmitter and the receiver of the first embodiment, heretofore explained referring to FIGS. 4 and 5, use infrared ray as wireless signals. The infrared ray communication system can be simple and inexpensive in the construction. However, the infrared ray has a nature of directivity so that it can emit the infrared ray only toward a narrow area. Therefore, a communication system in which a transmitter and a receiver can communicate in a wide area is required. The second embodiment is provided to accomplish this, wherein a transmitter and a receiver use radio wave instead of the infrared ray as wireless signals, and effectively radiate the wave toward wide area.

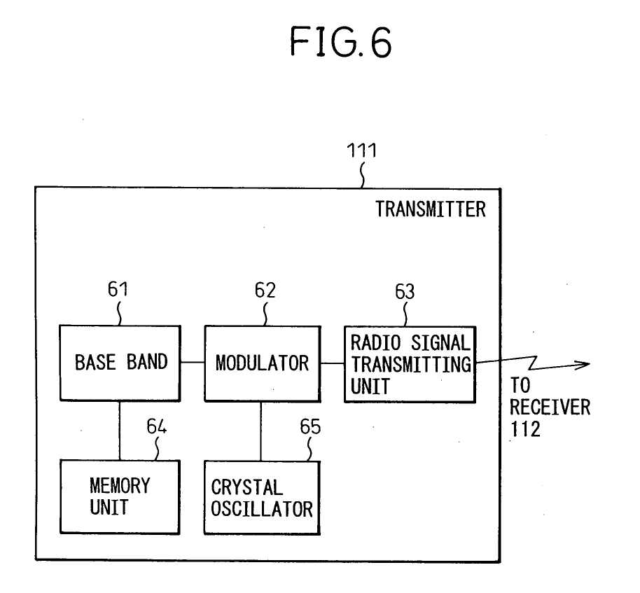

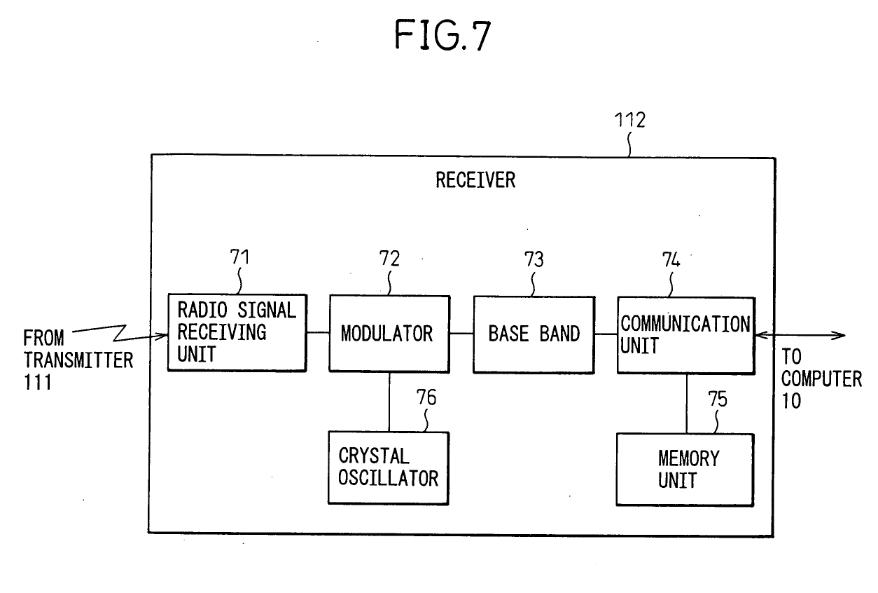

FIG. 6 is a functional block diagram of a transmitter of a second embodiment according to the present invention. The transmitter 111 transmits a radio wave as a wireless signal to a receiver 112 according to the second embodiment as shown in FIG. 7. Thus, the transmitter 111 includes a base band 61, a modulator 62, a radio signal transmitting unit 63, a memory unit 64 and a crystal oscillator 65. Herein, 2.45 GHz frequency band of the radio wave is used conforming to Bluetooth (trademark) Standard, useful for the short distance communication, for example having a range of about 10 meters.

The base band 61 receives an event of a push button operation, reads transmitting data corresponding to the push button stored in the memory unit 64 and converts the read transmitting data into an intermediate frequency signal that can be handled by the modulator 62 in accordance with a prescribed communication protocol.

The modulator 62 mixes an intermediate frequency signal output from the base band 61 with a basic frequency signal output from the crystal oscillator 65, modulates the mixed Signal to a radio signal with 2.45 GHz band, and transmits the radio signal to the radio signal transmitting unit 63.

The radio signal transmitting unit 63 amplifies the radio signal and transmits a radio wave toward the receiver 112.

FIG. 7 is a functional block diagram of a receiver of a second embodiment according to the present invention. The receiver 112 that receives a radio wave as a wireless signal from the receiver 12 includes a radio signal receiving unit 71, a modulator 72, a base band 73, a communication unit 74, a memory unit 75 and a crystal oscillator 76. The receiver 112 and the CPU 201 in the controller 20 are connected via the interface 206. Herein, 2.45 GHz frequency band of the radio wave is used conforming to “Bluetooth” (trademark) Standard, useful for the short distance communication, for example having a range of about 10 meters.

The radio signal receiving unit 71 receives a radio wave with 2.45 GHz band transmitted from the transmitter 111 and converts it to an electronic signal and passes it through a filter (not shown).

The modulator 72 mixes the electronic signal received from the radio signal receiving unit 71 and passed through the filter, with a basic frequency signal output from the crystal oscillator 76, converts it into an intermediate frequency signal, modulates it to a digital signal that can be handled by the base band 73, and transmits it to the base band 73.

The base band 73 receives the digital signal received via the radio signal receiving unit 71 and the modulator 72, converts it to data that can be handled by the CPU 201 in the controller 20, and sends it to the communication unit 74.

The communication unit 74 receives the data from the base band 73, transmits it to the computer 10. On the other hand, the communication unit 74 receives a command from the computer 10, reads personal ID data in a table (not shown) stored in the memory unit 75 in accordance with the command, and inputs the read personal ID data to the CPU 201 in the controller 20.

The memory unit 75 is composed of a RAM and stores tables as shown in FIG. 8A and FIG. 8B.

FIGS. 8A and 8B are drawings each showing an example of tables (A) and (B) stored in a receiver. In the memory unit 24 of the receiver 12, a table is reserved for registering personal ID data corresponding to wireless signals received from the transmitter 11. Data of the user A of the computer 10 is stored in the table A as shown in FIG. 8A, while data of the user B of the computer 10 is stored in the table B as shown in FIG. 8B. AS can be seen from FIGS. 8A and 8B, access destination, ID or identification number, PW or password, and utility, of the users A and B of the computer 10 are indicated in the top line, and by way of example, data concerning access destination, ID, PW corresponding to each of utility are indicated from the second line to the fifth line.

This table is used in the following way. First, the user watches a screen on a display (not shown) in the computer 10 on which the table A is displayed. On the screen, the user can see the table indicating that the first utility is “OS login”, the second utility is “on-line shopping”, the third utility is “budget management system” and the fourth utility is “screen saver activation/deactivation”. Next, the user depresses one of push buttons corresponding to the utility as shown in the table based on his or her choice. Then, the personal identification data such as the ID and the PW required to access to the destination corresponding to the selected utility is automatically input to the computer 10.

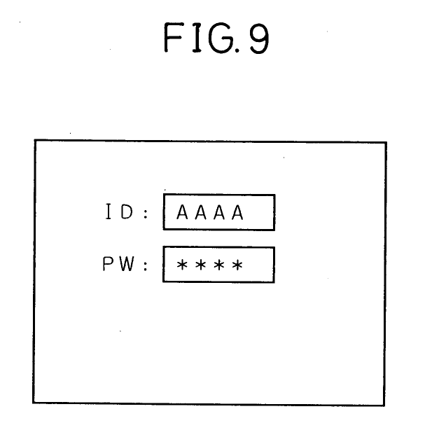

FIG. 9 is a drawing showing an example of a screen displayed on a display of a computer. Data of an ID and a PW of a user corresponding to utility in the table as explained above referring to FIGS. 8A and 8B, is set in response to a state of the screen on the display of the computer 10. FIG. 9 shows a screen state when the first utility “OS login” is processed. The computer 10 recognizes that this screen indicates a state just before “OS login” is accessed. Therefore, if the table is registered at this state, the user can register an ID and a PW required to input when the user accesses to “OS login”. Herein, push buttons ID/PW, SS, PRG1 and PRG2 as shown in FIG. 3 respectively correspond to “OS login”, “screen saver activation/deactivation”, “on-line shopping” and “budget management system”.

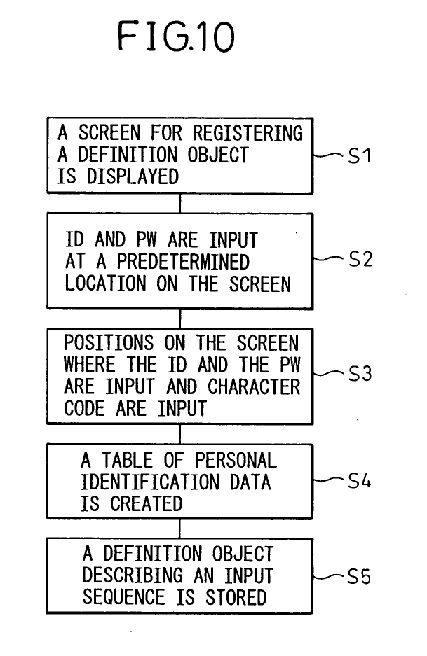

FIG. 10 is a flowchart showing a procedure of creating a definition object describing a sequence of entering at a computer in order to carry out the present invention. This definition object can be created by means of a computer as below.

First, in step S1, a screen for registering a definition object is displayed on a display of a computer in which an input sequence to a computer is described in the definition object. This screen is displayed when an ID and a PW are input to register them corresponding to each utility, as explained referring to FIGS. 8A and 8B, and the access destination.

In step S2, the user inputs an ID and a PW at a predetermined location on the screen with the use of a keyboard and/or a mouse.

In step S3, the positions on the screen where the ID and the PW are input in step S2 and character code such as alphanumerical characters, symbols etc. of the ID and the PW are temporary memorized in a RAM of the computer.

In step S4, a table is created and stored in the receiver. In the table, a personal identification data of a user of the computer including an ID and a PW for an access destination corresponding to each utility as shown in FIGS. 8A and 8B is registered.

In step S5, a definition object is stored in a RAM of the computer. Herein, an input sequence to the computer based on the screen location and the character code of the ID and the PW, temporary memorized in step S3, is described in the definition object. In this way, the input sequence to the computer used for inputting the ID and the PW for access destination corresponding to the utility, is registered.

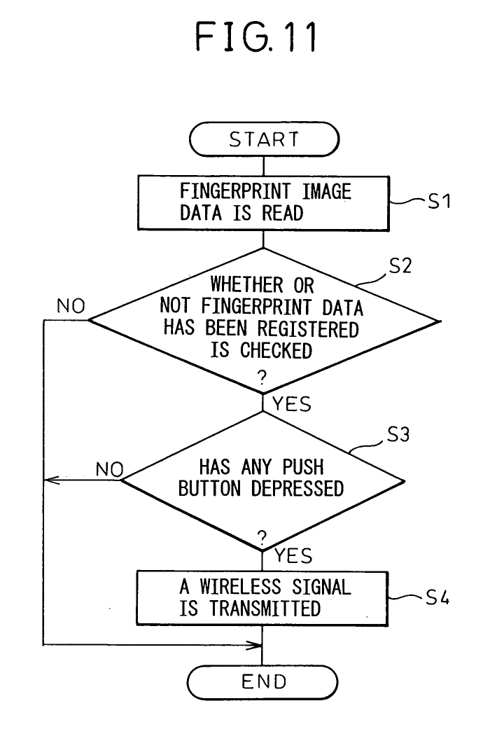

FIG. 11 is a flowchart showing a routine of a transmitter that authenticates an operator of the transmitter based on personal features of the operator. This routine is executed by the transmitter. With regard to personal features, there are signature patterns, fingerprints, palm prints, voice prints etc. For convenience, referring to FIGS. 1, 3 and FIG. 11, an embodiment of a transmitter that authenticates the operator of the transmitter based on the fingerprint as shown in FIG. 3, will be explained below.

First, in step S1, fingerprint image data input to the fingerprint input section 33 is read.

In step S2, the fingerprint data read in step S1 is compared with fingerprint data registered in advance in the fingerprint ROM, whether these data coincide or not is determined. If the coincidence is determined the process goes to step S3, if not, the process ends.

In step S3, whether any one of push buttons in push button input section 32 is depressed or not is determined. If the result is affirmative, the process goes to step S4, if the result is negative, the process ends.

In step S4, a wireless signal corresponding to the push button in the input section 32 depressed in step S3 is transmitted toward the receiver 12.

According to the above routine, the wireless signal is transmitted only when the operator of the transmitter is determined as a registered operator in advance based on the fingerprint so that the security can be improved.

There is provided another embodiment wherein signature patterns or palm prints are substituted for the fingerprints for the authentication of the user of the transmitter, the fingerprint reading section as shown in FIG. 4 is replaced by a signature pattern reading section or a palm print reading section, and the fingerprint ROM is replaced by a signature pattern ROM or a palm print ROM, and a routine similar to the above for the fingerprint is executed.

There is also provided another embodiment wherein signature patterns are substituted for the fingerprints for the authentication of the user of the transmitter, the fingerprint reading section as shown in FIG. 4 is replaced by a voiceprint pattern receiving section with a microphone, and the fingerprint ROM is replaced by a voiceprint pattern ROM, and a routine similar to the above for a fingerprint is executed.

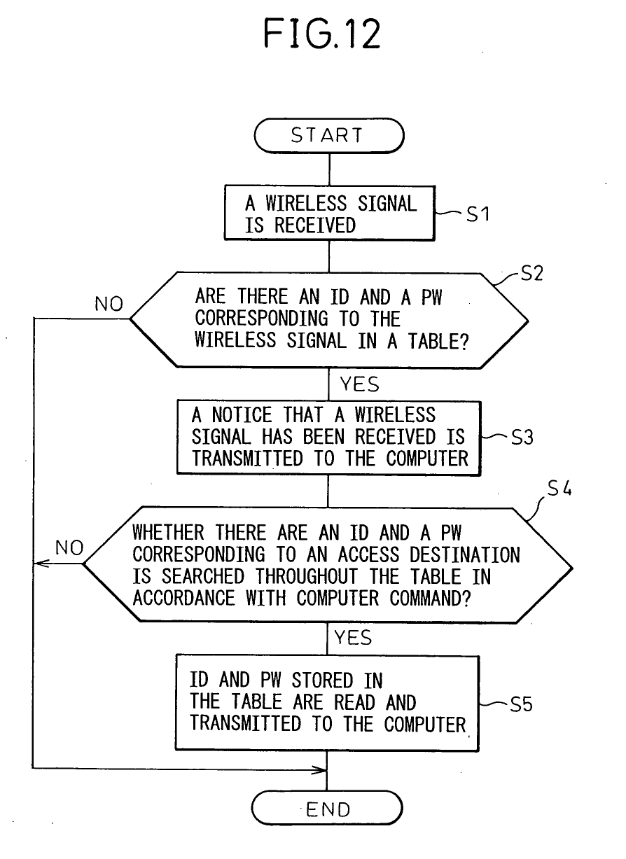

FIG. 12 is a flowchart showing a procedure of a receiver that receives a wireless signal from a transmitter and inputs a personal identification data to a computer. This input processing routine is executed by the receiver that receives a wireless signal from the transmitter, transmits the wireless signal to the computer and communicates with the computer. The wireless signal transmitted from the transmitter is triggered by depressing a push button in the transmitter by a user.

First, in step S1, a wireless signal transmitted from the transmitter is received.

In step S2, an ID and a PW corresponding to a wireless signal received from the transmitter are searched for in a table stored in the receiver. If the ID and the PW are found in the table, the process goes to step S3, if not, the process ends.

In step S3, a notice that a wireless signal has been received is transmitted to the computer.

In step S4, a command is received from the computer, and the receiver scans in order to search for the ID and the PW corresponding to an access destination throughout the table in the receiver. If the ID and the PW are found in the table, the process goes to step S5, if not, the process ends.

In step S5, the ID and the PW stored in the table are read and transmitted to the computer.

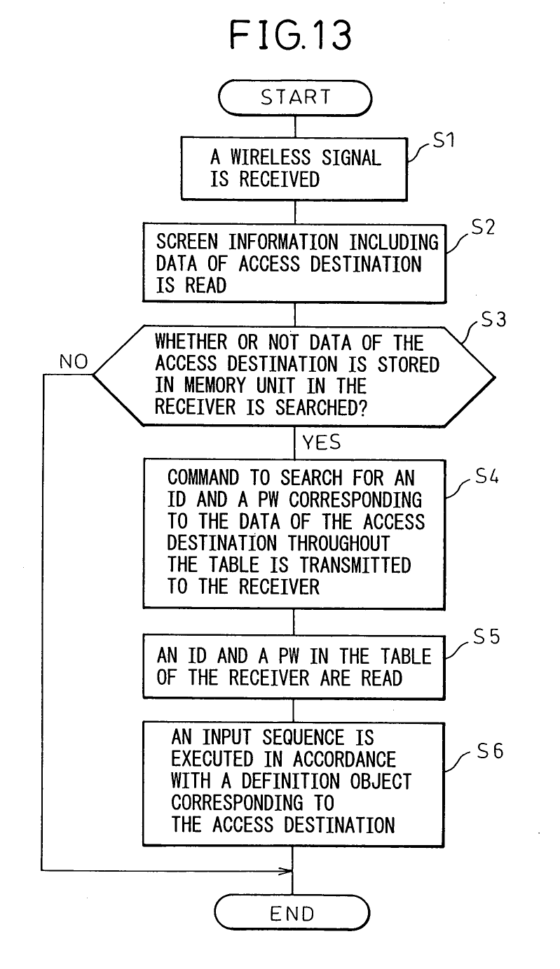

FIG. 13 is a flowchart showing a procedure that receives a wireless signal from a transmitter and inputs a personal identification data to a computer in accordance with a state of a screen of the computer. This input processing routine is executed by the computer after receiving a wireless signal from the transmitter via the receiver. The wireless signal transmitted from the transmitter is triggered by depressing a push button in the transmitter by a user.

First, in step S1, a wireless signal transmitted from the transmitter is received via the receiver.

In step S2, screen information on a display in the computer is read. This screen information includes data of access destination as shown in FIGS. 8A and 8B.

In step S3, data of the access destination read in step S2 is searched throughout the table stored in the memory unit in the receiver. If the data of the access destination is found in the table, the process goes to step S4, if not, the process ends.

In step S4, the process commands the receiver to search for an ID and a PW, corresponding to the data of the access destination, throughout the table stored in the receiver.

In step S5, the ID and the PW corresponding to the data of the access destination in the table are read from the receiver.

In step S6, an input sequence to the computer is executed in accordance with a definition object registered in advance corresponding to the access destination in the table.

In the embodiments heretofore explained, an example of a transmitter, as shown in FIG. 3, has been given, wherein the transmitter includes a plurality of push buttons each provided for accessing a unique destination being registered in advance. As another embodiment, a plurality of remote controllers each corresponding to a transmitter are provided, wherein the remote controller has only one push button that enables to register the corresponding unique access destination in advance.

In both embodiments, an ID and a PW in response to the corresponding wireless signal triggered by the corresponding push button can be input to a computer by simply depressing the push button in a remote controller for a transmitter. In the remote controller, a plurality of push buttons or only one push button may be provided. In the both embodiments, a unique access destination is registered in advance corresponding to a wireless signal. Herein, each different kind of wireless signal is triggered by depressing the corresponding push button.

A further embodiment may be provided wherein only one kind of wireless signal is transmitted, from a remote controller having a plurality of push buttons or, from a plurality of remote controllers each having a push button. In this embodiment, an ID and a PW corresponding to an access destination are registered depending on a screen state on a display of a computer in advance. Then, the ID and the PW corresponding to the screen state can be input to the computer by depressing the push button in the remote controller.

A remote controller authenticating a user of a computer according to the present inventions explained hereinabove is portable so that it can be carried as a key and, therefore, the security may be improved in comparison with a system in which a means of authenticating a user of a computer is built into a controller.

What is claimed is:

1. A system of authenticating a computer user comprising:
a transmitter that transmits a predetermined wireless signal;
a receiver that receives said wireless signal; and
a computer that communicates with said receiver and authenticates an operator of said transmitter after receiving said wireless signal as a trigger.

2. A system according to claim 1, wherein said computer comprises a registering unit that registers a personal identification data in advance corresponding to said wireless signal in a memory unit of said receiver.

3. A system according to claim 2, wherein said registering unit enters in advance said personal identification data in response to a screen state on a display of said computer in a memory unit of said receiver.

4. A system according to claim 2, wherein said receiver receives said wireless signal from said transmitter, indicates that it has received said signal to said computer, reads personal identification data corresponding to said wireless signal and registered in said memory unit, and inputs said read personal identification data to said computer.

5. A system according to claim 3, wherein said receiver receives said wireless signal from said transmitter, indicates that it has received said signal to said computer, reads personal identification data corresponding to said wireless signal and registered in said memory unit, and inputs said read personal identification data to said computer.

6. A system according to claim 2, wherein said receiver receives said wireless signal from said transmitter, indicates that it has received said signal to said computer; and
said computer reads personal identification data corresponding to said wireless signal from said receiver.

7. A system according to claim 3, wherein said receiver receives said wireless signal from said transmitter, indicates that it has received said signal to said computer; and
said computer reads personal identification data corresponding to said wireless signal from said receiver.

8. A system according to claim 2, wherein said receiver receives said wireless signal from said transmitter, indicates that it has received said signal to said computer; and
said computer reads personal identification data from said receiver, corresponding to screen information of said computer, when it has received said wireless signal.

9. A system according to claim 3, wherein said receiver receives said wireless signal from said transmitter, indicates that it has received said signal to said computer; and
said computer reads personal identification data from said receiver, corresponding to screen information of said computer, when it has received said wireless signal.

10. A system according to claim 1, wherein said transmitter comprises a authenticating unit that authenticates an operator of said transmitter based on at least one of personal features such as signature patterns, fingerprint patterns, palm print patterns, voiceprint patterns, or the like; and
said wireless signal is transmitted only when said operator is authenticated by said authenticating unit.

11. A method of authenticating a computer user, comprising the steps of:
receiving a notice that a predetermined wireless signal has been received via a receiver in which said wireless signal is transmitted from said transmitter and triggered by an operation of an operator of said transmitter; and
authenticating said operator of said transmitter as a result of the communication with said receiver.

12. A method according to claim 11, wherein reading personal identification data corresponding to screen information of said computer when said notice from said receiver is received.

13. A method according to claim 11, wherein said transmitter comprises the steps of authenticating an operator of said transmitter based on at least one of personal features such as signature patterns, fingerprint patterns, palm print patterns, voiceprint patterns or the like; and
transmitting said wireless signal only when said operator is authenticated.

14. A method according to claim 12, wherein said transmitter comprises the steps of authenticating an operator of said transmitter based on at least one of personal features such as signature patterns, fingerprint patterns, palm print patterns, voiceprint patterns or the like; and
transmitting said wireless signal only when said operator is authenticated.

15. A computer program for a method of authenticating a computer user that makes the computer execute the steps of:
receiving a notice that a predetermined wireless signal has been received via a receiver in which said wireless signal is transmitted from said transmitter and triggered by an operation of an operator of said transmitter; and
authenticating said operator of said transmitter as a result of the communication with said receiver.
